(19) United States
(12) Patent Application Publication
(10) Pub. No.: US 2008/0286727 A1
(43) Pub. Date: Nov. 20, 2008

(54) METHOD AND SYSTEM FOR TRAINING

(76) Inventor: Lou Nemeth, Irving, TX (US)

Correspondence Address: DLA PIPER US LLP, P. O. BOX 9271, RESTON, VA, 20195, US

(21) Appl. No.: 12/103,272

(22) Filed: Apr. 15, 2008

Related U.S. Application Data
(60) Provisional application No. 60/912,045, filed on Apr. 16, 2007.

(51) Int. Cl. G09B 7/00

(52) U.S. Cl. 434/30; 434/353; 434/362; 434/309; 434/317

(57) ABSTRACT

A computerized method and/or system for training over a network is provided, the method and/or system comprising: sending an item, over the network for evaluation related to a trainee; requiring an evaluator to evaluate the item in an evaluation, the evaluation including information on why the evaluation was given; receiving the evaluation over the network; generating a report comparing the evaluation to other evaluations performed by other evaluators, the report including the information on why each evaluation was given; determining needed change(s) based on the report; determining how to achieve the needed change; and providing materials over the network on how to achieve the needed change to the evaluator.

This application claims priority to patent application 60/912,045, filed on Apr. 16, 2007, and entitled “Method and System for Training”, which is herein incorporated by reference.

### BRIEF DESCRIPTION OF FIGURES

FIG. 1 illustrates a system for evaluating training, according to one embodiment.

FIG. 2 illustrates a method for evaluating training, according to one embodiment.

FIG. 3 illustrates an example of a report that can be generated by the system and/or method, according to one embodiment.

FIGS. 4-10 illustrate screen shots used in a system for evaluating training, according to one embodiment.

FIGS. 11-14 illustrate information regarding norms, standard deviations, and/or sigmas, according to one embodiment.

### DETAILED DESCRIPTION OF EMBODIMENTS OF THE INVENTION

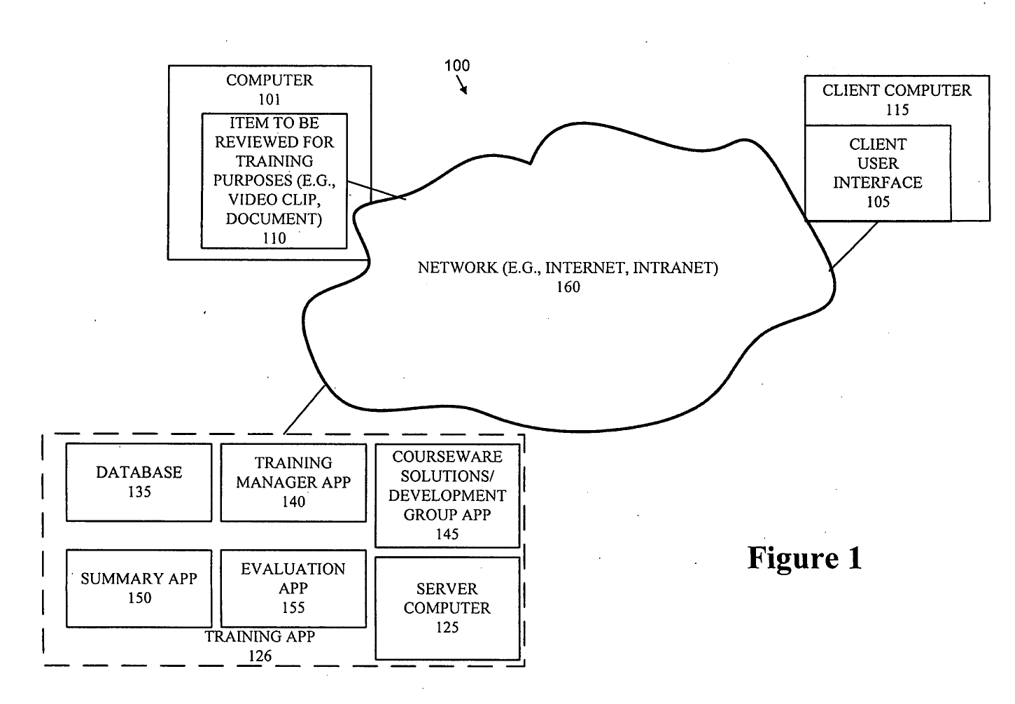

FIG. 1 illustrates a system 100 for evaluating training, according to one embodiment. Although flight training is described herein, those of ordinary skill in the art will see that any type of training where a person must teach another person to do something can be provided, including flight training, flight attendant training, aircraft mechanic training, training for managers on how to mentor employees, legal training, etc. At least one network of computers (e.g., the Internet, an intranet) 160 is utilized to facilitate communication involving the system for evaluating training between a client computer 115 and a server computer 125. The client computer 115 comprises a client user interface 105, which can be utilized by a trainer, evaluator, instructor, etc. (referred to hereafter as evaluators). The server computer 125 can include a summary application 150, an evaluator application 155, a database 135, a training manager application 140, and a courseware/solutions development group application 145. (These Objects are Described in More Detail Below.)

Items 110 that are to be reviewed can be stored and/or created in the server computer 125, or they can be separately stored and/or created, and accessed through the network 160. An item 110 may be, for example, a video clip of a trainee flying. Although a video clip is used as the item 110 for evaluation for illustration purposes herein, those of ordinary skill in the art will see that any other type of item (e.g., document) can be utilized. The video clip can be created on an ad hoc basis or at a regular time interval (e.g., monthly/quarterly) using, for example, a simulator camera, digital brief/debrief system, and/or other system. The video clip can be created by the evaluator, the trainee, or by another individual (e.g., by filming the trainee). As detailed below, the video clip can be sent to the evaluator, along with evaluation instructions indicating how to complete an evaluation of the video clip. The evaluators can view and score the video clip. Evaluations from multiple evaluators reviewing the same or different items 110 can be compared. The scores can be stored in a database file and tabulated. Scores or evaluations that are more than an accepted statistical deviation from the mean are noted, and the evaluators giving those scores can be required to explain the scores. Evaluation procedures can be updated based on information discovered when comparing the multiple evaluations. The explanations can be stored for potential review to help improve the training process. For example, a training manager could review one or more evaluations by several evaluators and conclude that the evaluation instructions for the review must be changed, or that an individual instructor must receive further training so that his/her evaluations are consistent with other evaluations. In addition, training issues that require attention can be identified rapidly. Furthermore, part or all of the system can take place across a network (e.g., Internet, Intranet), the evaluating is able to be done by multiple individuals in multiple locations, yet still take place in a short amount of time.

Referring to FIG. 1, the summary application 150 can be used to generate, notifications to evaluators (e.g., by email, phone, text message, etc.) to view and score items; such as documents or video clips. The summary application 150 can also generate reports of which evaluators are outside the norm (e.g., beyond a certain amount of standard deviation) in their evaluations, and why. The evaluators application 155 can be used by evaluators to view and score items, provide comments on why a particular score was given, and view or otherwise access information related to new standards. The database 135 can be used to store the items, the scores, and the instructor comments. Note that the database 135 can also convert the item in one format to another format. For example, a video clip can be converted and stored as a digital file in the database 135. The training manager application 140 can be used to create the items that are to be scored, create commentary on reports that indicate which instructors are outside of the norm and why, and send needed changes and approve solutions to help better standardize evaluations. The courseware solutions/development application 145 can be used to analyze the best way to implement a change. The courseware solutions/development application 145 can also be used to create new courseware; memos, videos, CBTs (Computer Based Training), manuals, etc., as appropriate to implement the requested changes.

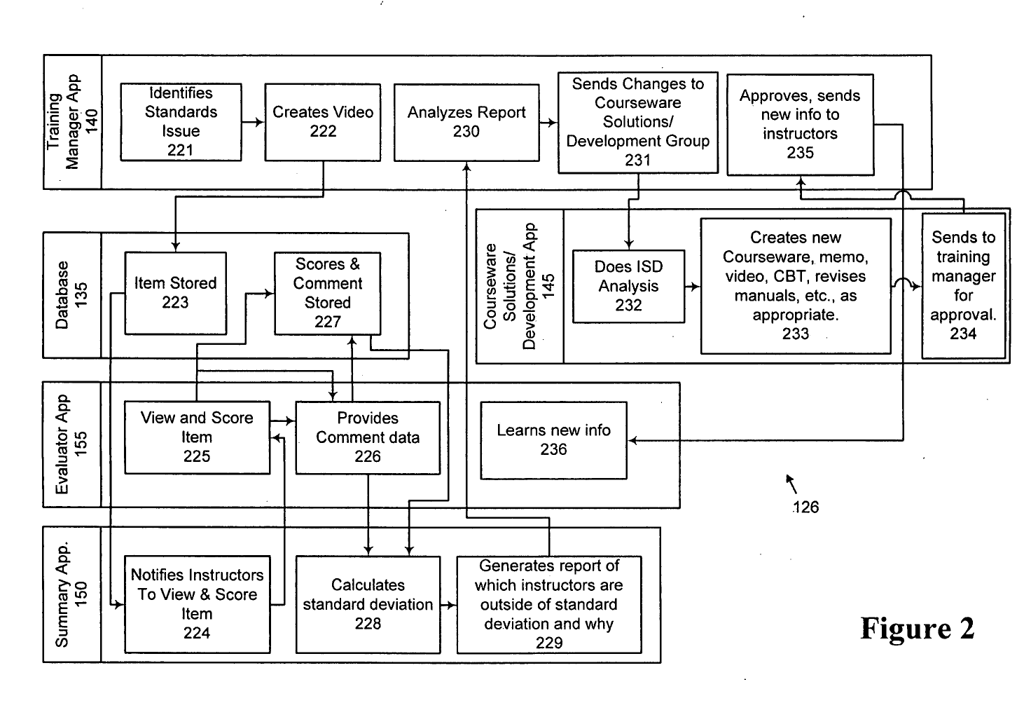

FIG. 2 illustrates a method for evaluating training, according to one embodiment. The method is illustrated by indicating which piece of system 100 accomplishes each function. In 221, at least one training manager can identify a standards issue in an organization using the training manager application 140. For example, the training manager can be a training manager for pilot trainers. The standards issue can be a technical standard or a human factor standard. For example, a technical standard could be that pilots are performing a certain function using different standards (e.g., going different speeds, using different terms to mean the same thing). A human factor standard can comprise leadership, problem-solving, crisis handling, communication, decision making, etc. For example, pilots, based on training from different, trainers, could be reacting differently to the same crisis scenario. In 222, once a standards issue is identified, a scenario that incorporates the standard can be created or recreated in an item such as a video using training manager application 140. In 223> the video can be digitized (if wanted) and stored as a computer file in database 135. In 224, evaluators can be notified (e.g., via email) to view and score the video through summary application 150. In 225, the evaluators view the video of a trainee performing one or more functions and scores the trainee's performance (e.g. trainee gets a score of 4 out of 5) through evaluators application 155. Evaluation instructions can be provided to the evaluators indicating how to complete a correct assessment. These evaluation instructions can help managers of the instructors achieve accountability because instructors can be given information which helps them complete a fair, complete, and consistent assessment. Not only can the trainees be evaluated, but the instructors can also be evaluated to measure how well each of them individually, as well as collectively, perform against the expectations indicated in the written directives. Thus, the training system can be more fair and consistent throughout an organization.

In 226, the evaluator provides comments on why the particular score was given (e.g. manual X indicates that a certain speed should be maintained when landing, and the trainee maintained a higher speed). In 227, the scores and comments are stored in the database 135. In 228, the scores from all evaluators are compared, and norms and/or sigmas and/or standard deviation information is calculated (more details on this calculation will be described below) in the summary application 224. In one embodiment, if an evaluator is determined to be outside of the norm and/or sigma and/or standard deviation, further comments can be solicited from such evaluators in order to provide more information on why the evaluator is not evaluating the item in a manner done by other evaluators.

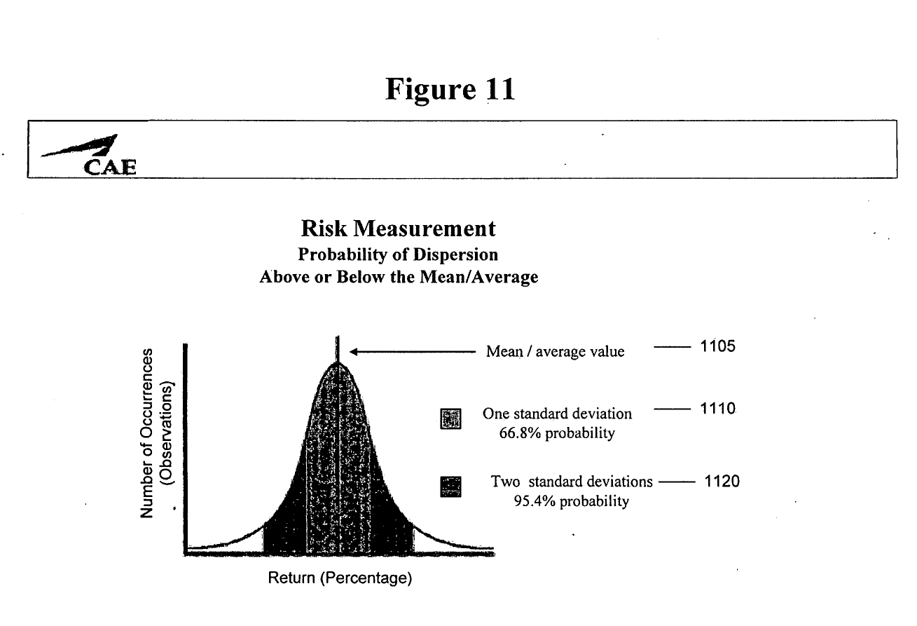

FIG. 11 illustrates a risk measurement of a set of evaluations, according to one embodiment. The mean/average value of evaluations is shown in 1105. In 1110, one standard deviation is determined to be a 66.8% probability. In 1120, two standard deviations is determined to be a 95.4% probability. The mean/average value and standard deviation information can be calculated according to accepted statistical procedures.

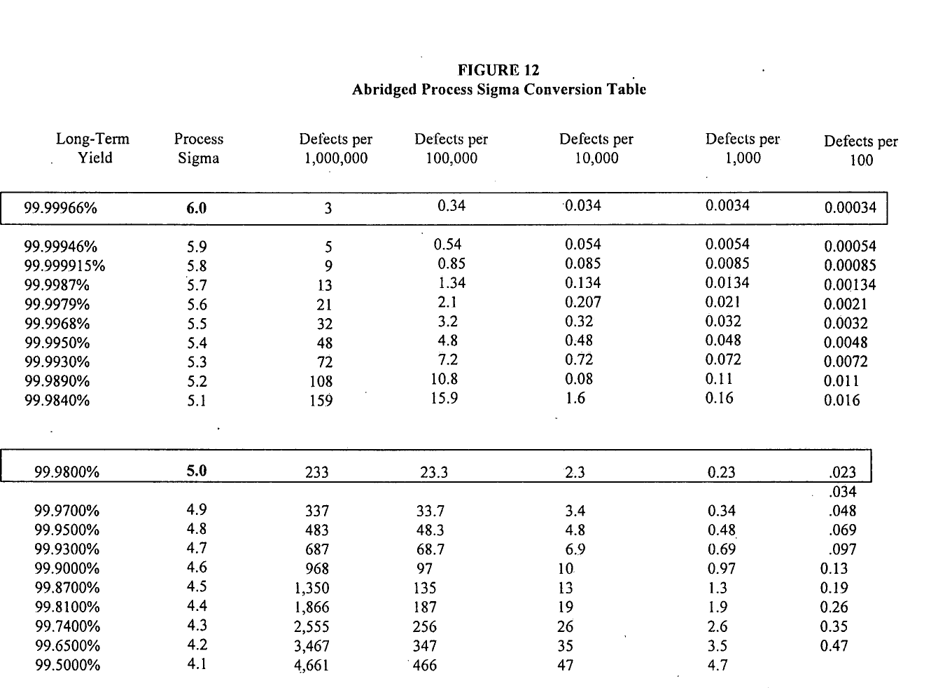

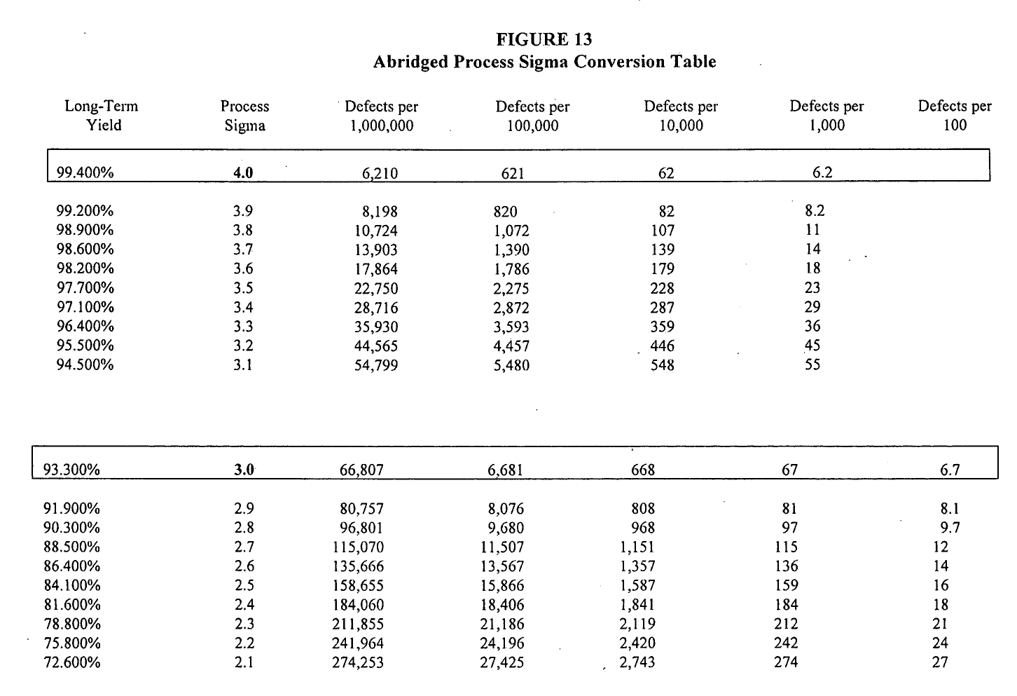

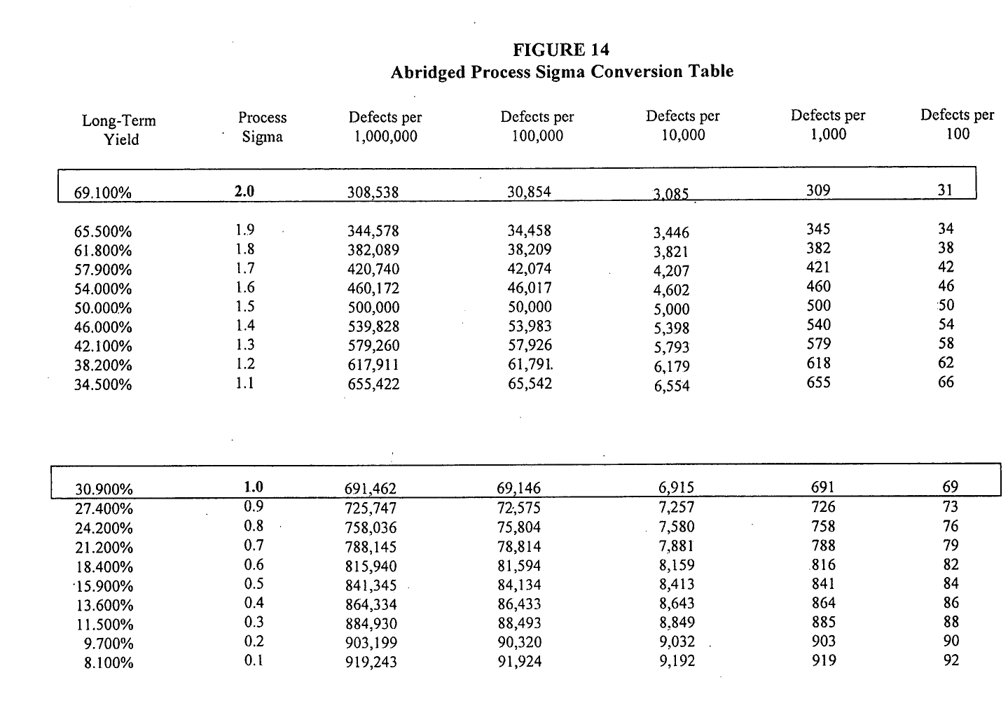

In another embodiment, a sigma value can be calculated. FIGS. 12-14 list several different sigmas. A sigma is a measure of the number of defects (e.g., per million). For example, 6 sigma equals 3 defects per million; 5 sigma equals 233 defects per million; and 4 sigma equals 6210 defect per million. There are several types of sigma calculations. For example, DPMO (Defects Per Million Opportunity) can be calculate. Alternatively, DPMU (Defects Per Million Units) can be calculate. A baseline sigma can be calculated by defining a unit as an item evaluated. A defect can be defined as a characteristic that does not meet minimum requirements. An opportunity can be defined as an event that provides a chance of not meeting a minimum requirement. For example, if there were 200 items being evaluated, and 3 opportunities for defects per item (e.g., 3 things that the evaluator could do wrong), and if 20 defects are made, than the DPMU is [(20)]/[(3)(200)]=0.0333. Since 0.0333×1 million=33,333, there are between 3.3 or 3.4 sigma in this example (see FIGS. 12-14). The DPMU can be calculated as follows: 20/200=0.1; 0.1×1 million= 100,000, so there are between 2.7 or 2.8 sigma (see FIGS. 12-14).

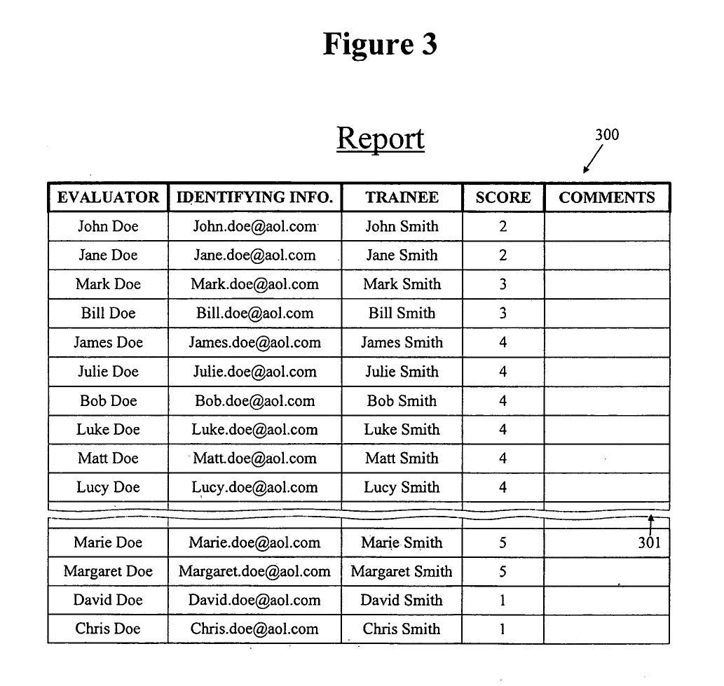

Returning to FIG. 2, in 229, a report is generated of which instructors are outside of a particular standard deviation and/or sigma and why. An example of a report 300 is illustrated in FIG. 3. Note that several names and other identification information for evaluators can be listed on the report 300. The names of the trainees can also be listed on the report 300. The scores that each evaluator gave each trainee can also be listed. In addition, comments provided by the evaluators can also be provided on the report 300. Furthermore, information, such as how far away certain evaluators are from the norm can be provided. For example, report 300 has a line 301 indicating that evaluators under that line are more than 1 statistical deviation from the scoring norm. Note that additional statistical information can be provided, such as different lines indicating different statistical deviations (1, 1.5, 2, etc.) In addition, note that the report can provide information on any level of statistical deviation (e.g., 0.3, 0.5, 1.5, etc.). For example, as time increases and training gets more and more consistent, reports could be generated indicating evaluators that were 0.5 statistical deviations from the norm instead of 1 statistical deviation. In addition, note that, while report 300 lists only one score for each evaluator, if an evaluator has completed more than one evaluation, the report could be adjusted accordingly. For example, each score could be listed on the report. Alternatively, the most recent score could be listed on the report. In another embodiment, the average score from all of the evaluators' evaluations could be used.

Returning to FIG. 2, in 230, the training manager can review and analyze the report (including the scores and the comments) through the training manager application 140 and decide on the next steps. For example, he could decide that the evaluation criteria are ambiguous, that a certain evaluator is not evaluating properly, that instruction materials are not effective or consistent, etc. For example, when analyzing the report, the training manager could see that one evaluator states in his comments that he gave a trainee a score of 1 because the trainee was going 20 miles per hour on the runway instead of 10 miles per hour as required in manual X. However, another evaluator could state that he gave a trainee a score of 3 because the trainee was going 20 miles per hour on the runway as required in manual Y. Thus, the training manager could determine that the training manuals are not consistent in this matter. Note that, while analyzing the report can be done by a person in one embodiment, in another embodiment, the analyzing could be done using search criteria (in addition to, or in place of the human analyzing) in training manager application 140. For example, training manager application 140 could access all training materials (e.g., manuals, powerpoints, software) using a search engine. Thus, for example, when a training manager identifies that runway speed limits are not consistent in the training manuals, all training materials could be searched for relevant keywords (e.g., runway) in order to identify all training materials that discuss this subject, so that these training materials can be reviewed and made consistent. (Note that this search can also be used in 232, discussed below.) In 231, the suggested changes made by the training manager can be sent to the courseware solutions/development application 145, which can be used in 232 to perform an instruction system design (ISD) analysis to determine an efficient way to implement the suggested change. For example, it can be determined that the most efficient way to correct the inconsistencies in runway speed training could he to do a memo to all evaluators regarding the correct runway speed (instead of, for example, updating all of the manuals that mention runway speed). As noted above, searches of all training materials can be utilized in performing the ISD. In 233, information representing the determined best way to implement the suggested change is completed. For example, it could be done by creating new courseware, memos, video, CBT, and/or revised manuals. In 234, the information representing the best way to implement the suggested change is sent to the training manager for review. In 235, the training manager reviews the information through training manager application 1401 and, if approved, sends it to the relevant evaluators. In 236, the evaluators access and learn the new information through evaluation application 155.

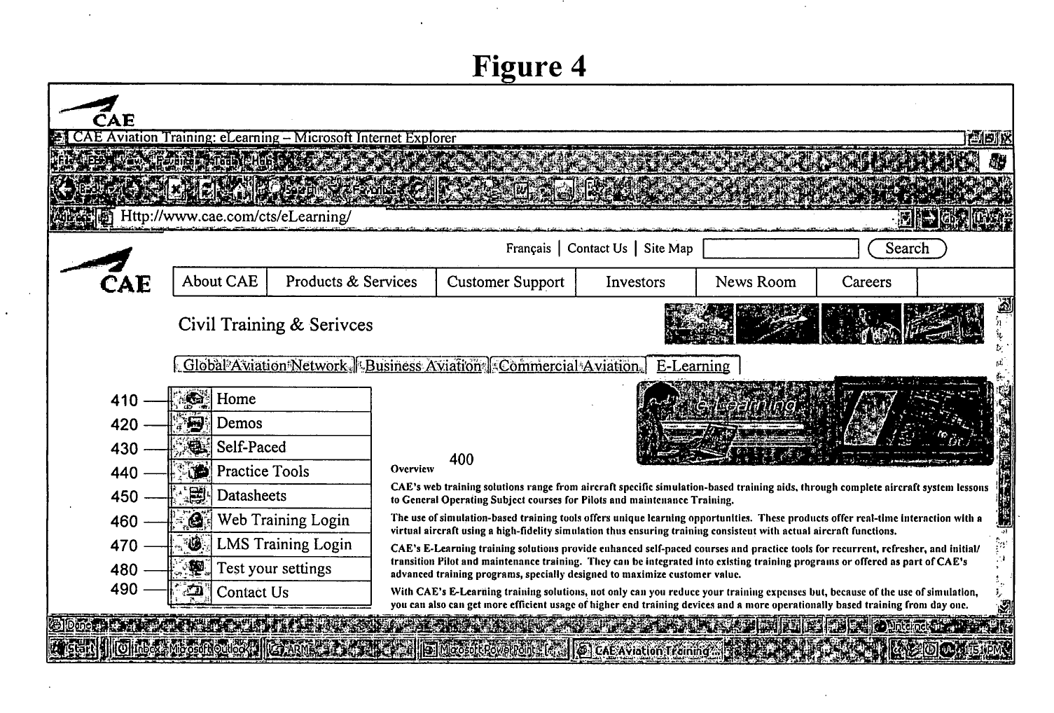

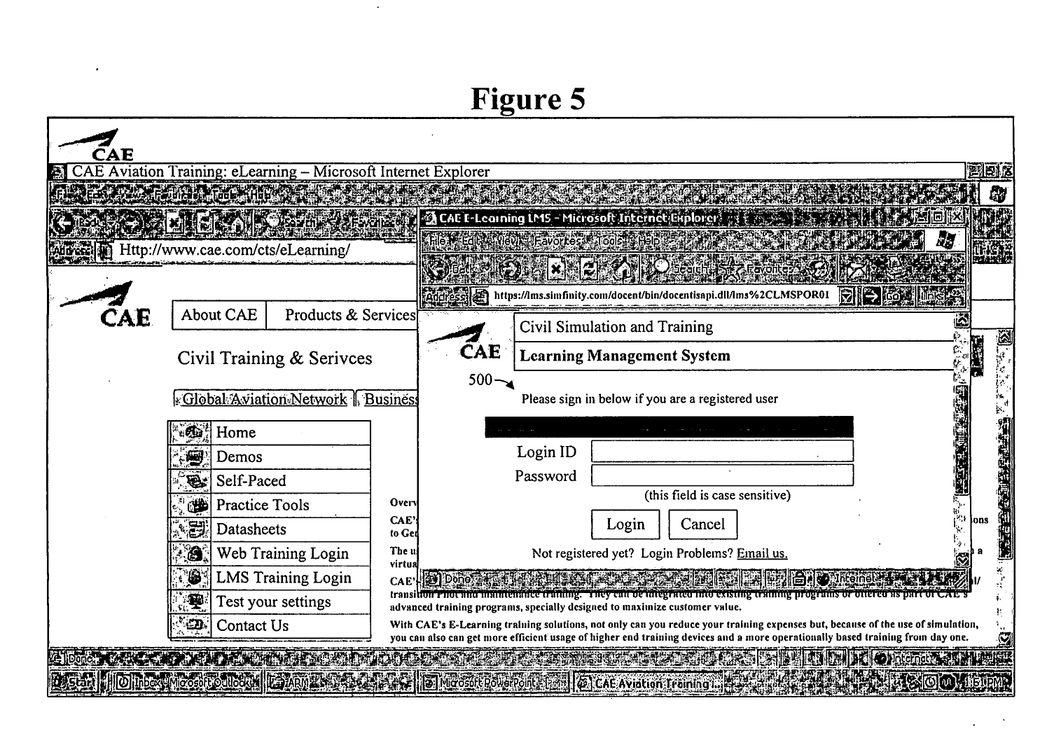

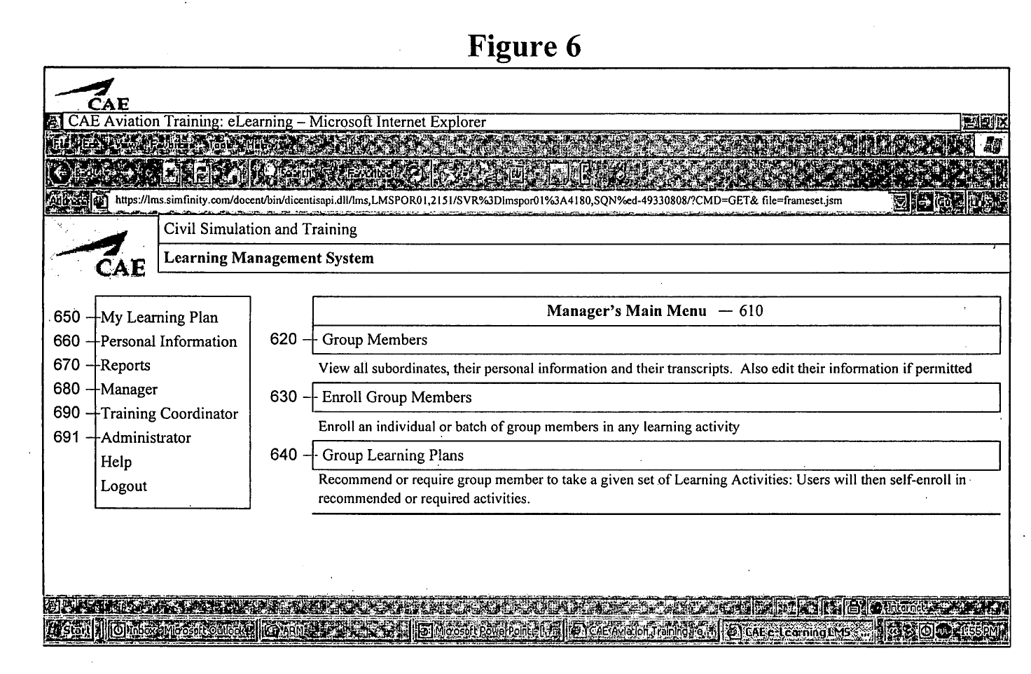

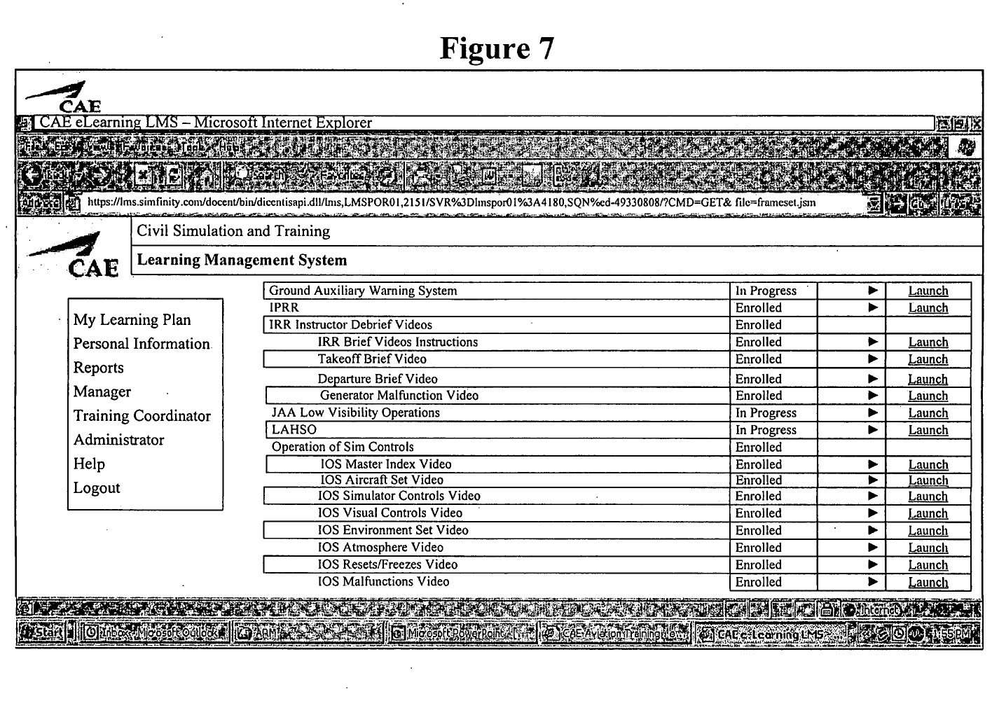

FIGS. 4-10 illustrate screen shots used in a system for evaluating training, according to one embodiment. FIG. 4 illustrates an e-learning overview screen shot 400 providing background information on the training solutions. Home 410 indicates that the user viewing the screen shots is at a home page. Demos 420 provides demonstrations on how various items should be evaluated. Self-Paced 430, Practice Tools 440, Datasheets, 450, LMS (Learning Management System) Training Login 470, Test Your Settings 480 and Contact Us 490 can be provided by a general learning management system (LMS) as tools that can be applied to the application, as well as other applications. Web Training Login 460 takes a user (e.g., a training manager or a trainer/evaluator) to a login page 500 (see FIG. 5) that accepts login information. (Note that the login capability can be optional.) In FIG. 6, once the user has logged in (if required), a Manager's Main Menu 610 can appear. This can be accessed by training managers. The Group Members 620 can allow a training manger to view all subordinates, their personal information, and their transcripts. This information can be edited, if permitted under the rules set up by a system administrator. In Enroll, Group Members 630, a trainer or a group of trainers can be enrolled in a learning activity (e.g., an evaluation). In Group Learning Plans 640, trainers (i.e., members) can be recommended or required to take certain sets of learning activities. Trainers can then self-enroll in such learning activities. In other embodiment, a training manager or other person could enroll for the member. My Learning Plan 650 could be accessed to know what trainers/evaluators need to accomplish. Personal Information 660 could provide personal information, on trainees and/or evaluators and/or training managers and/or training coordinators. Reports 720 can be used by training managers to generate reports such as report 300 discussed above. Manager 680 can be used by training managers. Training Coordinator 690 can be used by training coordinators to coordinate appropriate training. FIG. 7 is a screen shot illustrating a capability to rate evaluation reliability, according to one embodiment. In one embodiment, this screen shot can appear automatically based on a database that tracks which lessons should be made available to a unique user. In another embodiment, a user could click on a specific link to bring up this screen shot (or a similar screen shot). FIG. 7 indicates that IRR (Inner Rater Reliability) Instructor Debrief Videos can include: IRR Brief Videos instructions (which can provide an evaluator instructions on how to properly evaluate a trainee); and Takeoff Brief Video, Departure Brief Video, and Generator Malfunctions Brief Video, which can all be video clips of trainees doing the indicated function.

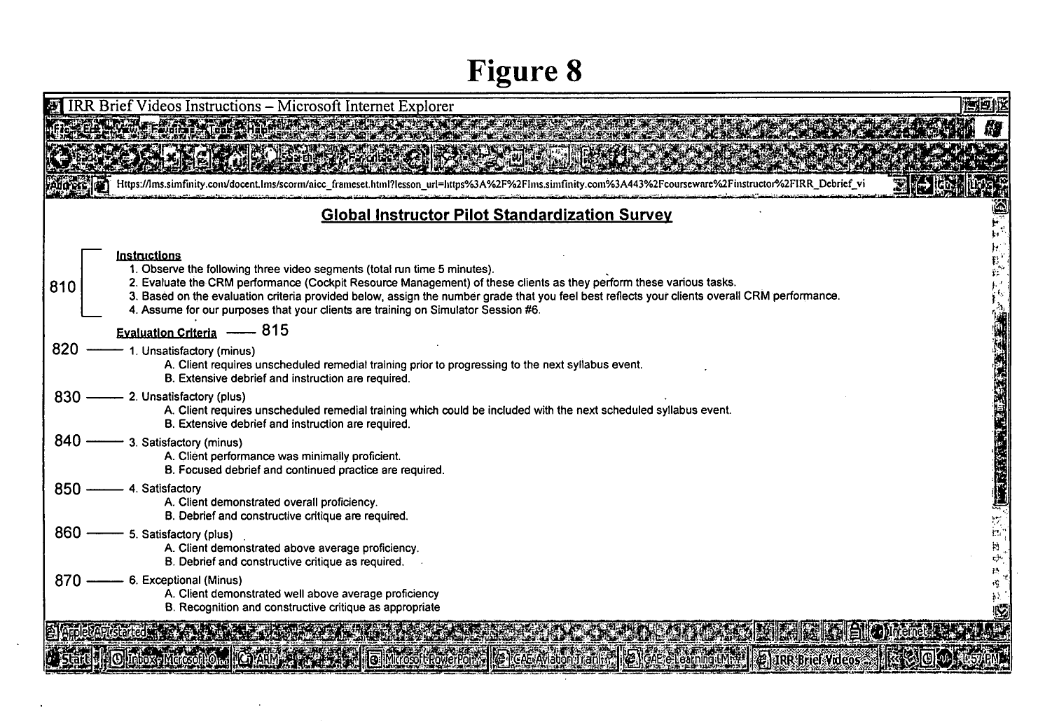

FIG. 8 illustrates one example of evaluation criteria 800, according to one embodiment. In one embodiment, this, information can appear automatically as the first screen of each IRR lesson. In another embodiment, a user could click on a specific link to bring up this screen. The evaluation criteria can be shown when the evaluator views and scores the item in 225 (see FIG. 2). The evaluation criteria 815 sets forth clearly what each number grade should represent. Unsatisfactory (minus) Grade 1 (820) should represent that: a) the trainee requires unscheduled remedial training prior to progressing to the next syllabus event; and b) extensive debrief and instruction are required. Unsatisfactory (plus) Grade 2 (830) should represent that: a) the trainee requires unscheduled remedial training which could be included with the next scheduled syllabus event and b) extensive debrief and instruction are required. Satisfactory (minus) Grade 3 (840) should represent that: a) the trainee performance was minimally proficient and b) focused debrief and continued practice are required. Satisfactory—Grade 4 (850) should represent that: a) the trainee demonstrated overall proficiency and b) 1 debrief and constructive critique are required. Satisfactory (plus)—Grade 5 (860) should represent that: a) the trainee demonstrated above average proficiency and b) debrief and constructive critique are required. Exceptional (minus)—Grade 6 (870) should represent that a) the trainee demonstrated well above average proficiency and b) debrief and constructive critique are required.

Note that evaluation instructions are also included in 810: 1) observe three video segments (for three trainees); 2) evaluate the Cockpit Resource Management (CRM) performance of the trainees as they perform the tasks shown in the video segments; 3) using the evaluation criteria, assign a number grade that best reflects the trainee's overall CRM performance; and 4) assume trainees are training on a particular session (e.g., Simulator Session #6).

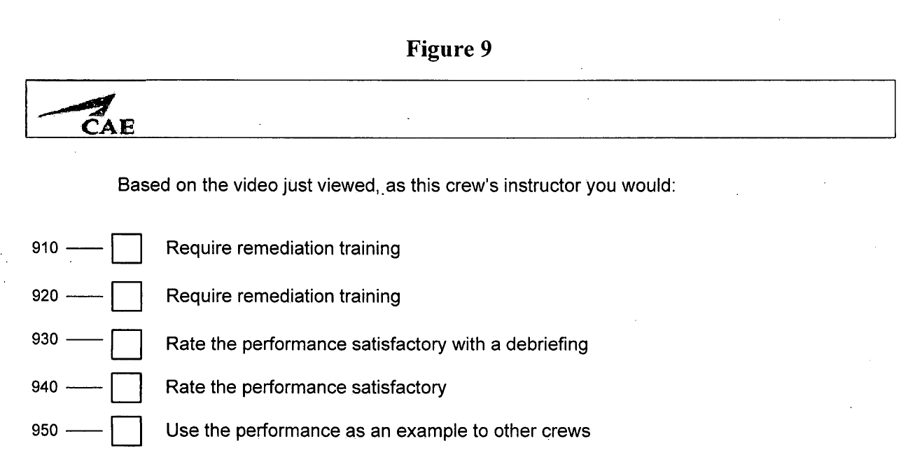

FIG. 9 illustrates another example of evaluation criteria 900. As mentioned above, the evaluation criteria can be shown when the evaluator views and scores the item in 225 (see FIG. 2). Grade 1 (910) should represent that the trainee requires remedial training. Grade 2 (920) should represent that the trainee requires additional practice without additional training. Grade 3 (930) should represent that the trainee performance was satisfactory with a debriefing. Grade 4 (940) should represent that the performance was satisfactory. Grade 5 (950) should represent that the performance could be used as an example to others. Note that FIGS. 8 and 9 represent examples of grading criteria, and that any other type or number of grading criteria could be used.

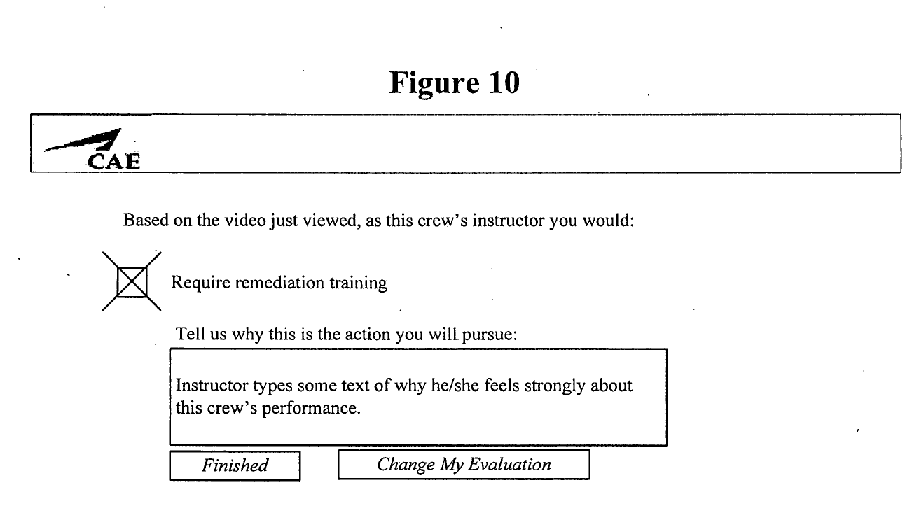

FIG. 10 illustrates an example of how an evaluator would fill in an evaluation using the criteria of FIG. 9. The evaluator chooses “requires remediation training” and then indicates why in the comments.

While various embodiments have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way. Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computerized method of training over at least one network, comprising:
sending at least one item over the at least one network for evaluation related to at least one trainee;
requiring at least one evaluator to evaluate the at least one item in at least one evaluation, the at least one evaluation including information on why the at least one evaluation was given;
receiving the at least one evaluation over the network;
generating at least one report comparing the at least one evaluation, to other evaluations performed by other evaluators, the at least one report including the information on why each evaluation was given;
determining at least one needed change based on the at least one report;
determining how to achieve the needed change; and
providing materials over the at least one network on how to achieve the needed change to the at least one evaluator.

2. The method of claim 1, further comprising:
if the at least one evaluation is substantially different from the other evaluations, requiring the at least one evaluator to further explain the evaluation.

3. The method of claim 1, wherein the at least one item is at least one video.

4. The method of claim 1, wherein the at least one item is at least one document.

5. The method of claim 1, wherein the training is transportation-related training.

6. The method of claim 5, wherein the training is flight training.

7. The method of claim 1, wherein the materials provided over the network on how to achieve the needed change to the at least one evaluator comprise: a video, a manual, a memo, or any combination thereof.

8. The method of claim 1, wherein the at least one report includes scoring information.

9. The method of claim 1, wherein at least two items are sent for evaluation, the at least two items being different.

10. The method of claim 9, wherein at least two evaluators evaluate the at least two items.

11. A computerized system for training over at least one network, comprising at least one processor with at least one application configured for:
sending at least one item over the at least one network for evaluation related to at least one trainee;
requiring at least one evaluator to evaluate the at least one item in at least one evaluation, the at least one evaluation including information on why the at least one evaluation was given;
receiving the at least one evaluation over the network;
generating at least one report comparing the at least one evaluation to other evaluations performed by other evaluators, the at least one report including the information on why each evaluation was given;
determining at least one needed change based on, the at least one report;
determining how to achieve the needed change; and
providing materials over the at least one network on how to achieve the needed change to the at least one evaluator.

12. The system of claim 11, wherein the at least one application is further configured for:
if the at least one evaluation is substantially different from the other evaluations, requiring the at least one evaluator to further explain the evaluation.

13. The system of claim 11, wherein the at least one item is at least one video.

14. The system of claim 11, wherein the at least one item is at least one document.

15. The system of claim 11, wherein the training is transportation-related training.

16. The system of claim 15, wherein the training is flight training.

17. The system of claim 11, wherein the materials provided over the network on how to achieve the needed change to the at least one evaluator comprise: a video, a manual, a memo, or any combination thereof.

18. The system of claim 11, wherein the at least one report includes scoring information.

19. The system of claim 11, wherein at least two items are sent for evaluation, the at least two items being different.

20. The system of claim 19, wherein the application is configured to allow at least two evaluators to evaluate the at least two items.
